(19) United States
(12) Patent Application Publication
(10) Pub. No.: US 2005/0269795 A1
(43) Pub. Date: Dec. 8, 2005

(54) Vehicle axle suspension bracket with squeeze attachment interface

(76) Inventors: Jack R. McKenzie, Clarkston, MI (US); Jaw-Ping Pan, Lake Orion, MI (US); Mark Smith, Troy, MI (US); Harry W. Trost, Rochester Hills, MI (US); Thomas D. Buley, Berkley, MI (US); Dale J. Eschenburg, Rochester Hills, MI (US); Paul G. Bragan, Clarkston, MI (US); Rajesh J. Somnay, Troy, MI (US); Tjong T. Lie, Naperville, IL (US); Everett Hall, Farmington Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/148,154

(22) Filed: Jun. 8, 2005

Related U.S. Application Data
(60) Provisional application No. 60/578,045, filed on Jun. 8, 2004.

(51) Int. Cl. B60G 9/02

(52) U.S. Cl. 280/124.11

(57) ABSTRACT

A suspension bracket is supported by an axle housing and is used to attach a vehicle suspension to the axle housing. The axle housing includes a polygonal cross-section including obliquely orientated corner portions that extend between adjacent vertical and horizontal walls. The suspension bracket includes a base portion, a pair of bracket legs, and contact pads that extend between each bracket leg and the base portion. Each bracket leg engages a protruding portion that extends outwardly from one of the vertical walls. A pressure force is applied to secure the suspension bracket to the axle housing. The pressure force squeezes the suspension bracket around the axle housing to generate a clamp load. The clamp load is exerted by the contact pads against the corner portions of the axle housing. Fore/aft loading and torsional loading are transferred from the axle housing to the suspension bracket via the corner portions.

### RELATED APPLICATIONS

The application claims priority to U.S. Provisional Application No. 60/578,045, which was filed on Jun. 8, 2004.

### TECHNICAL FIELD

This invention generally relates to a vehicle axle assembly including a suspension bracket that provides a clamp-load between corners of an axle housing and the suspension bracket by utilizing a squeeze attachment interface.

### BACKGROUND OF THE INVENTION

Heavy duty vehicles can include various different types of axles that drive, steer, and/or support the vehicle. A typical tractor-trailer combination will include a front non-drive steer axle and a tandem drive axle for the tractor, and a plurality of non-drive/non-steer trailer axles for the trailer. Suspensions are mounted between each of the different types of axles and a tractor or trailer frame member. Typically, suspensions are mounted to axle housings with brackets, clamps, etc.

There are many different types of suspensions. Further, each axle type can have many different configurations, including different axle housing sizes and different cross-sectional shapes. This results in many different types of brackets being used to attach the suspension to the axle, which results in part proliferation and increased cost. Further, due to the variations in suspensions and axles there are many different mounting locations on the axles themselves. Different bracket geometries combined with variable mounting locations can cause the axle housing to experience high stress concentrations or high stress loading in areas that are not best suited for high stress.

For the above reasons, it would be desirable provide an integrated suspension bracket that could be used to mount an axle to the various suspensions. The suspension bracket should be easily attached to the axle housing and should direct loading from the axle housing to the suspension in predetermined areas to better distribute stress, in addition to overcoming other deficiencies in the prior art as outlined above.

### SUMMARY OF THE INVENTION

A suspension bracket is supported by an axle housing and is used to attach a vehicle suspension to the axle housing. The axle housing includes opposing wall portions that have protruding portions extending outwardly from external surfaces of each opposing wall portion. The suspension bracket includes a pair of bracket legs that are positioned adjacent the opposing wall portions. Each bracket leg includes a distal end portion that is positioned adjacent one protruding portion. A pressure force is applied to the pair of bracket legs to secure the suspension bracket to the axle housing.

In one example, the axle housing includes a pair of vertical walls, a pair of horizontal walls, and obliquely orientated corner portions that extend between adjacent vertical and horizontal walls. Each vertical wall includes one protruding portion that extends outwardly from an external surface of the vertical wall. The protruding portion is preferably formed as a wedge or ramp, and includes an inclined surface.

The suspension bracket includes a base portion, a pair of bracket legs, and contact pads that extend between each bracket leg and the base portion. The distal end portions of each bracket leg directly engage one protruding portion. The pressure force squeezes the suspension bracket around the axle housing to generate a clamp load. The clamp load is exerted by the contact pads against the corner portions of the axle housing. Fore/aft loading and torsional loading are transferred from the axle housing to the suspension bracket via the comer portions.

The subject invention provides an integrated suspension bracket that can be utilized for mounting the axle housing to many different types of suspensions. The suspension bracket is easily attached to the axle housing by using a pressure force application, and directs loading from the axle housing to the suspension in predetermined areas to better distribute stress. These and other features of the present invention can be best understood from the following specification and drawings, the following of which is a brief description.

### BRIEF DESCRIPTION OF THE DRAWINGS

FIG. 1 is a schematic representation of a drive axle assembly incorporating the subject invention.

FIG. 2 is a schematic representation of a non-drive axle assembly incorporating the subject invention.

FIG. 3 is a cross-sectional view of a suspension bracket and axle housing assembly designed according to the subject invention.

FIG. 4 is a cross-sectional view of a suspension bracket and axle housing assembly designed according to another embodiment of the subject invention.

### DETAILED DESCRIPTION OF THE PREFERRED EMBODIMENT

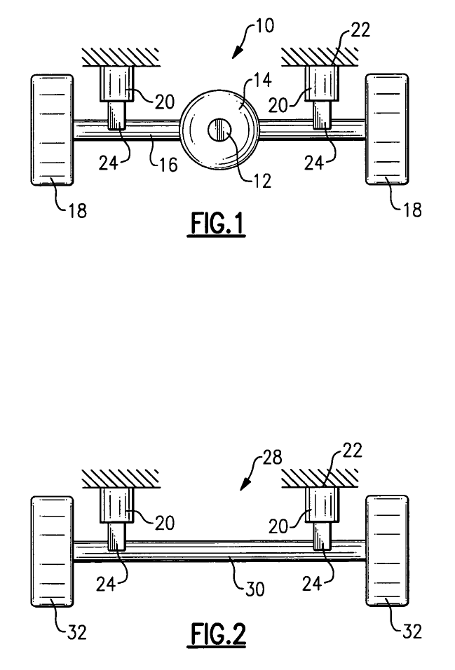

A drive axle assembly 10, shown in FIG. 1, includes a driving input 12 coupled to a center differential 14 enclosed within an axle housing 16. The center differential 14 drives a pair of wheel ends 18 mounted on opposing ends of the axle housing 16. A vehicle suspension, schematically shown at 20, is mounted between the drive axle assembly 10 and a vehicle frame 22.

A suspension bracket 24 is supported by the axle housing 16 to attach the vehicle suspension 20 to the axle housing 16. The suspension bracket 24 is mounted to the axle housing 16 prior to installing suspension components on the axle housing 16. Many different types of suspensions can be mounted to a common axle housing 16 by using this unique suspension bracket 24. Additionally, the suspension bracket 24 is configured to direct loading from the axle housing 16 to the suspension bracket 24 through predefined areas to provide improved stress distribution. This will be discussed in greater detail below.

While a drive axle assembly 10 is shown in FIG. 1, it should be understood that the subject invention could also be utilized in combination with a non-drive axle assembly 28, as shown in FIG. 2. In this configuration, an axle housing or axle beam 30 extends between a pair of wheel ends 32. The suspension bracket 24 is mounted to the axle beam 30 and is used to mount the vehicle suspension 20 between the non-drive axle assembly 28 and the vehicle frame 22.

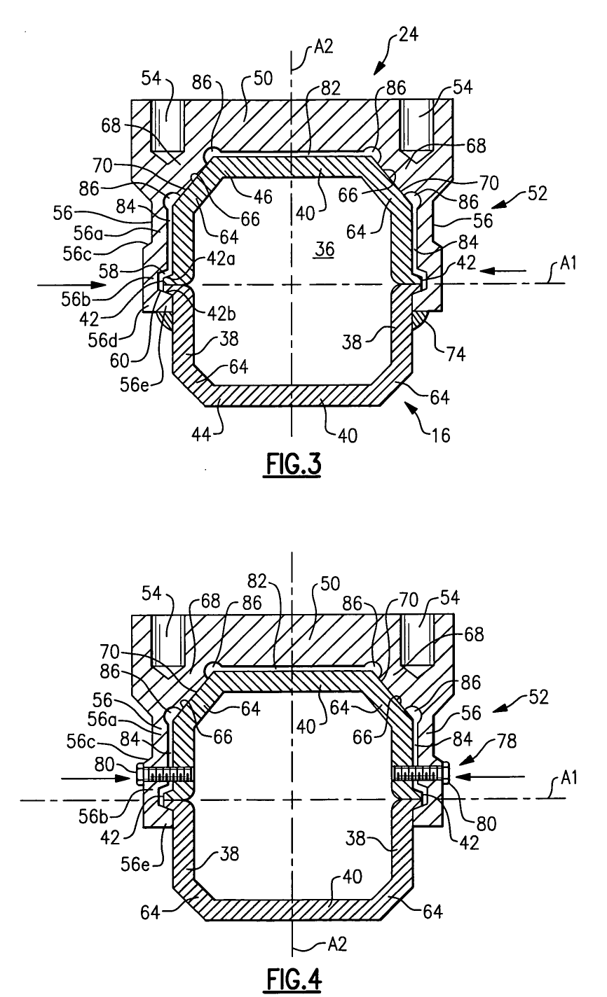

For either of the axle embodiments, the suspension bracket 24 and axle beam 30 or axle housing 16 are similarly configured as shown in FIG. 3. In this example, the axle housing 16 includes a polygonal cross-section that is defined by a plurality of housing walls that cooperate with each other to define an inner cavity 36. The plurality of walls includes a pair of vertical walls 38 and a pair of horizontal walls 40. The vertical walls 38 are positioned opposite from each other along a longitudinal vehicle axis A1 (fore-aft axis) and the horizontal walls 40 are positioned opposite from each other along a vertical axis A2.

Each vertical wall 38 includes a protruding portion 42 that extends outwardly from an external wall surface. These protruding portions 42 can be formed into a stamped housing half or cast into a cast housing. The axle housing 16 is preferably made from first 44 and second 46 housing halves. Each of the first 44 and second 46 housing halves includes a protruding portion formed in each vertical wall portion. The protruding portions from each housing half 44, 46 are aligned with each other prior to attaching the housing halves 44, 46 to each other.

The protruding portions 42 are formed as a wedge, ramp, flare, or other similar shape. Each protruding portion 42 includes an inclined surface that cooperates with the suspension bracket 24 in a manner that is described in greater detail below. When the protruding portions are aligned with one another, they cooperate with each other to form a combined protruding portion 42 that extends outwardly from the external wall surface. This combined protruding portion 42 has upper 42a and lower 42b inclined surfaces. The lower inclined surface 42b is provided by the first housing half 44 and the upper inclined surface 42a is provided by the second housing half 46.

The suspension bracket 24 has a base portion 50 that is attached to the vehicle frame 22 and an axle mount portion 52 that cooperates with the protruding portions 42. Mounting holes 54 are formed in the base portion 50 to facilitate attachment to the vehicle frame 22. A pressure force, indicated by the arrows, is applied to the axle mount portion 52 to mount the suspension bracket 24 to the axle housing 16. The axle mount portion 52 comprises a pair of bracket legs 56 that extend downwardly from opposite edges of the base portion 50. One bracket leg 56 is positioned adjacent one vertical wall 38 such that the suspension bracket 24 generally surrounds an upper portion of the axle housing 16.

Each bracket leg 56 includes a first leg portion 56a that extends from the base portion 50 in a direction generally parallel to a corresponding vertical wall 38. The first leg portion 56a transitions into a second leg portion 56b via an inclined portion 56c that extends generally away from the vertical wall 38. The second leg portion 56b extends downwardly, in a direction generally parallel to the vertical wall 38, to a distal end portion 56d. The distal end portion 56d includes an inwardly extending portion 56e that abuts directly against the vertical wall 38.

A recess 58 is formed within each bracket leg 56 along the second leg portion 56b and inwardly extending portion 56e. The protruding portions 42 are received within the recesses 58 of the corresponding bracket legs 56. The lower inclined surface 42b of the protruding portion 42 abuts directly against a recess wall 60 that extends along the inwardly extending portion 56e.

As described above, the axle housing 16 is defined by a polygonal cross-section. Transitioning between each adjacent horizontal wall 40 and vertical wall 38 is an obliquely orientated corner portion 64. Each corner portion 64 provides an inclined housing contact surface 66 that extends obliquely relative the horizontal 40 and vertical 38 walls.

The suspension bracket 24 includes angled contact pads 68, with one contact pad 68 extending between the base portion 50 and the first leg portion 56a of each bracket leg 56. Each contact pad 68 includes an inclined pad contact surface 70 that directly engages one of the inclined housing contact surfaces 66.

A pressure force, indicated by the arrows, is applied against each bracket leg 56 to mount the suspension bracket 24 to the axle housing 16. The pressure force and protruding portions 42 cooperate to provide a clamp-load on the corner portions 64 of the axle housing 16. This results in suspension input loads being transferred from the axle housing 16 to the suspension bracket 24 only through the corner portions 64, which provides more uniform load and/or stress distribution.

The pressure force can be applied in various manners. In the example shown in FIG. 3, a weld joint interface 74 is formed between the axle housing 16 and the suspension bracket 24. Preferably, the weld joint interface 74 is formed between the second leg portion 56b of each bracket leg 56 and the corresponding vertical wall 38 at a position vertically below the protruding portions 42. The pressure force is generated during a seam welding process, which is well-known in the art.

Optionally, a bolted joint interface 78, as shown in FIG. 4, can be used to apply the pressure force. The pressure force is generated in response to fasteners 80 being secured, via the bolted joint interface 78, to the suspension bracket 24 at the axle mount portion 52. The fasteners 80 connect each bracket leg 56 to a corresponding vertical wall 38 at a position vertically above the protruding portions 42.

In either configuration, the pressure force squeezes the suspension bracket 24 around an upper half of the axle housing 16, as indicated by the arrows, to generate a clamp load. As discussed above, the clamp load is exerted against the corner portions 64 of the axle housing 16. This results in fore/aft loading and torsional loading being transferred from the axle housing 16 to the suspension bracket 24 via the corner portions 64. By only transferring loading through the corner portions 64, more uniform loading and/or stress distribution is provided. In other words, improved loading and stress distribution characteristics are provided by controlling or directing a loading path through predetermined, desired areas between the suspension bracket 24 and axle housing 16.

The base portion 50 of the suspension bracket 24 is spaced apart from an upper horizontal wall 40 by a predetermined distance to form an upper gap area 82. The first leg portions 56a of each bracket leg 56 are separated from the corresponding vertical wall 38 by a predetermined distance to form side gap areas 84. Additionally, positioned on each side of each contact pad 68, is a recessed area 86 that extends into the suspension bracket 24. The upper gap area 82, side gap areas 84, and recessed areas 86 cooperate to further define the desired loading path. These areas also cooperate to provide pinion angle control for the driving input 12 to the drive axle assembly 10 (FIG. 1).

The subject invention provides a suspension bracket 24 that is integrated onto an axle housing 16 or axle beam 30, and which can be utilized for mounting the axle housing 16 or axle beam 30 to many different types of suspensions resulting in part de-proliferation. The suspension bracket 24 is easily attached to the axle housing 16 by using a pressure force application, and directs loading from the axle housing 16 to the vehicle suspension 20 in predetermined areas to better distribute stress.

Although preferred embodiments of this invention have been disclosed, a worker of ordinary skill in this art would recognize that certain modifications would come within the scope of this invention. For that reason, the following claims should be studied to determine the true scope and content of this invention.

1. An axle assembly comprising:
an axle housing including at least one housing wall having a protruding portion; and
a suspension bracket having a base portion attachable to a vehicle structure and including an axle mount portion cooperating with said protruding portion wherein a pressure force is applied to said axle mount portion to secure said suspension bracket to said axle housing.

2. The assembly of claim 1 wherein said axle housing is defined by a polygonal cross section including at least two corner portions and wherein the pressure force and protruding portion cooperate to provide a clamp-load on said at least two corner portions.

3. The assembly of claim 2 wherein suspension input loads are transferred from said axle housing to said suspension bracket through said at least two corner portions.

4. The assembly of claim 1 including a bolted joint interface between said suspension bracket and said axle mount portion wherein the pressure force is generated in response to at least one fastener being secured via said bolted joint interface to said suspension bracket and said axle mount portion.

5. The assembly of claim 1 including a weld joint interface between said axle housing and said suspension bracket wherein the pressure force is generated by said weld joint interface.

6. The assembly of claim 1 wherein said protruding portion extends outwardly from an external surface of said at least one housing wall.

7. The assembly of claim 6 wherein said axle mount portion comprises a bracket leg including a recessed portion, said protruding portion being received within said recessed portion.

8. The assembly of claim 7 wherein said bracket leg includes a distal end portion that extends inwardly toward said at least one housing wall, said distal end portion directly engaging said protruding portion.

9. The assembly of claim 1 wherein said at least one housing wall comprises a pair of horizontal wall portions and a pair of vertical wall portions with protruding portions extending outwardly from each vertical wall portion.

10. The assembly of claim 9 wherein the pressure force is applied against said pair of vertical wall portions.

11. The assembly of claim 9 wherein said base portion of said suspension bracket is spaced apart from one of said pair of horizontal wall portions by a distance.

12. The assembly of claim 11 wherein said axle mount portion of said suspension bracket comprises a pair of vertically extending legs with each leg being positioned adjacent to one of said pair of vertical wall portions.

13. The assembly of claim 12 including corner portions formed between each horizontal wall portion and each vertical wall portion, said corner portions extending obliquely relative to an adjacent horizontal wall portion and an adjacent vertical wall portion.

14. The assembly of claim 13 wherein said suspension bracket includes contact pads formed between each vertically extending leg and said base portion wherein said contact pads engage corresponding corner portions on said axle housing.

15. A method for attaching a suspension bracket to an axle housing comprising the steps of:
(a) forming a protruding portion on an external surface of an axle housing;
(b) engaging an axle mount portion of a suspension bracket with the protruding portion;
(c) exerting a pressure force against the axle mount portion to squeeze the axle housing; and
(d) securing the suspension bracket to the axle housing during application of the pressure force.

16. The method of claim 15 wherein step (d) includes welding the suspension bracket to the axle housing.

17. The method of claim 15 wherein step (d) includes fastening the suspension bracket to the axle housing via a bolted joint interface.

18. The method of claim 15 including the steps of:
forming the axle housing with a polygonal cross-section to include a pair of vertical wall portions, a pair of horizontal wall portions, and corner portions extending between each vertical wall portion and horizontal wall portion with the corner portions providing an inclined engagement surface;
forming the suspension bracket with a base portion adapted for attachment to a vehicle structure and the axle mount portion extending from the base portion toward the axle housing, the axle mount portion including a pair of bracket legs with one bracket leg being positioned adjacent each vertical wall portion, and including contact pads extending between each bracket leg and the base portion; and
wherein steps (b) and (c) cooperate to provide a clamp load between each contact pad and a corresponding inclined engagement surface on the axle housing.

19. The method of claim 18 including the step of transferring suspension input loads from the axle housing to the suspension bracket solely through an interface between the contact pads and corresponding inclined engagement surfaces.

20. The method of claim 15 including the steps of forming protruding portions on opposing axle housing wall portions such that each protruding portion has an inclined surface; forming the axle mount portion as a pair of bracket legs with one bracket leg being positioned adjacent one of the opposing axle housing wall portions, with each bracket leg including a distal end portion extending inwardly toward the axle housing; and directly engaging each distal end portion with a corresponding inclined surface of the protruding portion.
